(19) United States
(12) Patent Application Publication
(10) Pub. No.: US 2017/0288240 A1
(43) Pub. Date: Oct. 5, 2017

(54) Fuel cell power generation module

(71) Applicants: SZU-HAN WU, Taoyuan City (TW); Shih-Wei CHENG, Taoyuan City (TW); Wei-Hong SHIU, Taoyuan City (TW); Jing-Kai LIN, Taoyuan City (TW); Hung-Hsiang LIN, Taoyuan City (TW); Yung-Neng CHENG, Taoyuan City (TW); Ruey-Yi LEE, Taoyuan City (TW)

(72) Inventors: SZU-HAN WU, Taoyuan City (TW); Shih-Wei CHENG, Taoyuan City (TW); Wei-Hong SHIU, Taoyuan City (TW); Jing-Kai LIN, Taoyuan City (TW); Hung-Hsiang LIN, Taoyuan City (TW); Yung-Neng CHENG, Taoyuan City (TW); Ruey-Yi LEE, Taoyuan City (TW)

(21) Appl. No.: 15/088,105

(22) Filed: Mar. 31, 2016

(51) Int. Cl. H01M 8/04014; H01M 8/04119; H01M 8/04746; H01M 8/04701; H01M 8/0612

(52) U.S. Cl. CPC H01M 8/04022; H01M 8/04708; H01M 8/0618; H01M 8/04738; H01M 8/04776; H01M 8/04141

(57) ABSTRACT

A fuel cell power generation module includes a fuel cell stack body combined with a reformer, a burner, and a plate-type evaporator that are sequentially top-down stacked and assembled into a detachable power generation module, a gas-water separator to recycle mixed fuel that is not completely reacted with the fuel cell stack body, and a part of the recycled fuel is introduced into the burner for burning, and the burner thermal thus produced is used for heating the fuel cell stack body and the plate-type evaporator through thermal radiation and heat conduction, meanwhile, hot air produced by the burner can be used for heating air that enters the fuel cell stack body, and the plate-type evaporator converts the water into steam that feeds into the fuel cell stack body with fuel for reaction.

### BACKGROUND OF THE INVENTION

### 1. Field of the Invention

The fuel cell power generation module of present invention relates to a high efficiency fuel cell power generation module, in particular to using recycled fuel to minimize low efficiency burning reaction and raise fuel utilization rate and power generation efficiency for the fuel cell power generation module.

### 2. Description of Related Art

The fuel cell can be categorized in two types based on high and low working temperatures, and because of high temperature fuel cell has higher efficiency, it is to input directly to the anode the fuel gas, such as methane, without using a noble metal electrode catalyst that is adopted in low working temperature type fuel cell. This is an advantage of the high working temperature type fuel cell, thus the development of high temperature fuel cells in recent years is drawing attentions. In order to pursue higher and more stable power generation performance, many countries have invested a large amount of manpower and resources to carry out research and system testing in aspects including electrolytes, electrode catalysts, coupling plates, and other materials in the fuel cell kinetics and reaction mechanism.

In general, a high temperature fuel cell power generation system uses a hydrogen-rich fuel electrochemical reaction to produce electricity, and the residual part that didn't carry out electrochemical reaction is guided into the burner for combustion reaction to enhance the heat exhaust, and its thermal energy thus generated is provided for system operation. However, if the system generates excessive heat that exceeds what is needed by the system, it will increase risk of system operation. The high temperature fuel cell is heated to high working temperatures (700˜800° C.) or even higher, so most of thermal system components are integrated into a single unit, causing difficult replacement for the internal reform catalyst.

In the field of high temperature fuel cells, it is essential to make a sound thermal management and fuel material recycling work to improve fuel cell power generation efficiency. The high efficiency fuel cell power generation module generally adopted recycling mechanism for feeding the recycled fuel back to the fuel inlet and regulating the ratio of fuel feeding to the catalyst burner, thus maintaining the desired temperature and preventing the occurrence of low-fuel flameout.

U.S. Patent US 2010/0136378 A1 system disclosed a reformer and burner integrated design. Although it can prevent hydrogen combustion tempering, however, when the fuel is in the lean zone, it tends to turn off the flame and cause the system to cease functioning.

U.S. Pat. No. 7,156,886 B2 disclosed a reformer and burner integrated design with directly piled up structure, in which the burner is arranged below the reformer so as to provide heat to the reformer with its exhaust gas after combustion for fuel recombination. The heat generated by such a reformer and burner structure suffers a great loss, and there is much room for thermal management improvement.

In view of the disadvantages mentioned above, the inventors aims to solve these shortcomings and thus bring up the present invention with highly effective heat and fuel recycling mechanism.

### SUMMARY OF THE INVENTION

The primary object of the present invention is to provide a highly efficient fuel cell power generation module. The residual fuel of a fuel cell stack body is recycled and supplied to a burner as the fuel for burning, and the heat generated by the burner is used in part for direct heating the fuel cell stack body and a plate-type evaporator, and the rest of the heat is used for heating residual air from the fuel cell stack body, and the heated air is used for preheating fresh air introduced into the fuel cell stack body. The plate-type evaporator can convert input water into steam that enters with fuel into the fuel cell stack body. Therefore, it is not only recycling residual fuel but also enhancing heat conductivity to promote the efficiency for overall power generation module.

Another object of the present invention is to provide a highly efficient fuel cell power generation module that includes a fuel cell stack body, a bottom plate, a burner and a plate-type evaporator, of which the four parts are erected in a vertical stack arrangement with the fuel cell stack body placed at the bottom, wherein the heat transfer in between each part is enhanced through direct contact. By preheating the fresh air flowing in pipes arranged in a fence type surrounding the circumference of the fuel cell stack body, it takes full advantage of the heat produced by the burner to reduce the amount of heat radiation and fuels waste and improve the overall economic interests.

In order to achieve the object mentioned above, the present invention provides a fuel cell stack body combined with a reformer, wherein a positive electrode and a negative electrode are connected inside the fuel cell stack body through a fuel flow path and an air flow path, respectively, wherein a fuel inlet and a fuel outlet are provided at each end of the fuel flow path, respectively, and an air inlet and an air outlet are provided at each end of the air flow path, respectively.

A burner rendered at one side of the fuel cell stack body, wherein the burner has an air input port communicating with the air outlet of the air flow path and a hot air outlet; a plate type evaporator attached on a side of the burner farther from the base of the fuel cell stack.

A gas-water separator communicating with the gas outlet of the fuel cell stack body for receiving and separating residual fuel and water for recycling, introducing a part of recycled fuel to the burner inlet to mix with the air that flows out of the burner air outlet into the burner for burning, heating the air that exits from the hot air outlet of the burner, wherein a portion of heat is directly transferred to the plate-type evaporator and the stack of the base, wherein the recycled fuel is flowing through the plate-type evaporator after refueling, and the recycled water is introduced into the plate-type evaporator after refilling, and the plate-type evaporator absorbing the heat of the burner and converting the water into steam that flows with the fuel into the fuel inlet of the fuel cell stack body.

A plurality of multilayer pipes are provided on the peripheral of the fuel cell stack body, wherein each of the multilayer pipe is composed of an outer pipe covering the peripheral of an inner pipe, one end of the inner pipe communicating with the hot air outlet of the burner for guiding the hot air output from the burner, and the outer pipe introduces a fresh air from one end into the outer pipe, and the other end of the outer pipe communicating with the air inlet of the fuel cell stack body that receives the fresh air being heated by the inner pipe while flowing into the fuel cell stack body.

In accordance with the structure mentioned above, a plate with high heat conductivity mounted between the fuel cell stack body and the burner, wherein the fuel cell stack body and the burner are attached on the top and bottom sides of the plate, respectively.

In accordance with the structure mentioned above, the recycled fuel and water separated by the gas-water separator were delivered to the plate-type evaporator through a composite pipe having an inner pipe for guiding recycled water to the plate-type evaporator, an outer pipe for guiding recycled fuel to flow through the plate-type evaporator, and an intermediate pipe for guiding externally refilled fuel to flow through the plate-type evaporator.

In accordance with the structure mentioned above, a plurality of multilayer pipes provided on the peripheral of the fuel cell stack body are connected each other and arranged in parallel fence fashion surrounding the circumference of the fuel cell stack body.

In accordance with the structure mentioned above, the burner is a catalyst type burner having a porous catalyst carrier for generating burning reaction with hydrogen and air at room temperature.

In accordance with the structure mentioned above, the plate-type evaporator has porous filler materials furnished inside for separation and expansion of the water passing through the plate-type evaporator to increase heat transfer efficiency.

In accordance with the structure mentioned above, the fresh air is preheated by a preheater prior to entering the outer pipe.

Other objects advantages and novel features of the invention will become more apparent from the following detailed description when taken in conjunction with the accompanying drawings

### BRIEF DESCRIPTION OF THE DRAWINGS

FIG. 1 is a schematic view of the structure of the present invention;

FIG. 2 is a front view of the structure of the present invention;

FIG. 3 is a rear view of the structure of the present invention; and

FIG. 4 is a schematic view in partial section of the structure of the present invention;

### DETAILED DESCRIPTION OF THE PREFERRED EMBODIMENTS

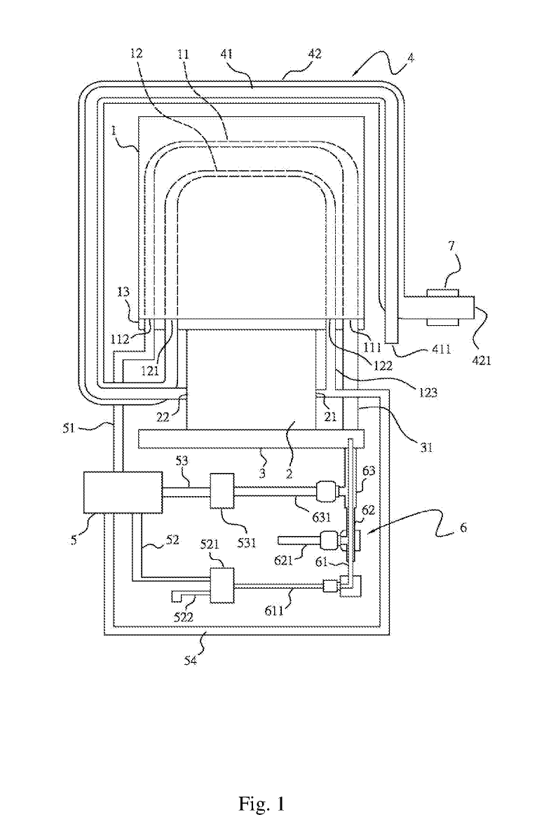

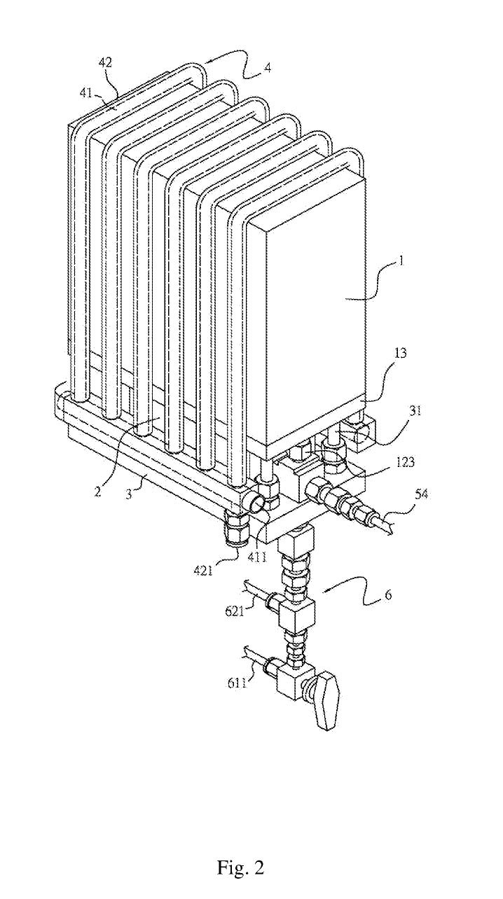

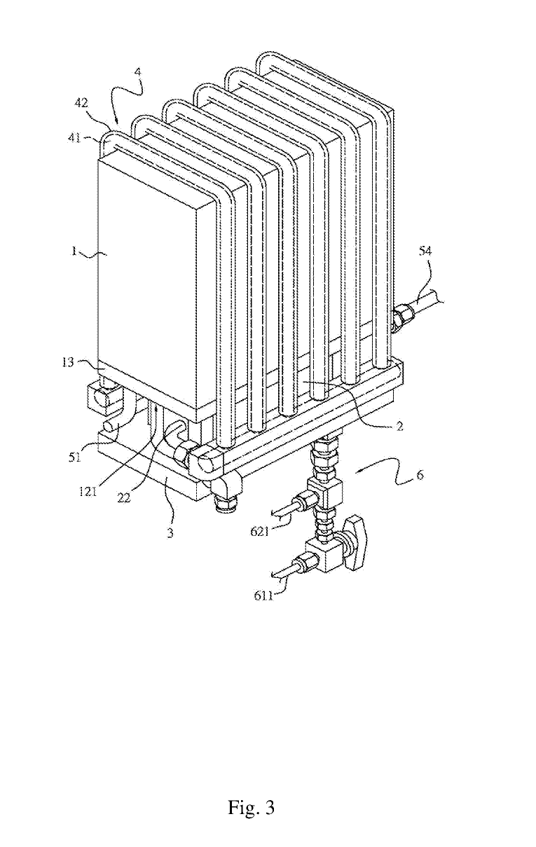

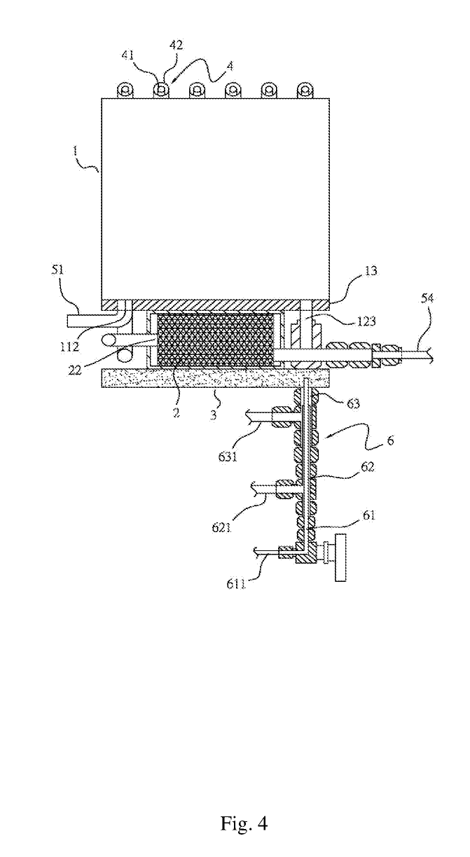

Referring to FIG. 1-4, The structure of the present invention includes a fuel cell stack body 1, a burner 2, a plate-type evaporator 3, multilayer pipes 4, a gas-water separator 5 and composite pipes 6. The fuel cell stack body 1 is combined with a reformer, and a positive electrode and a negative electrode are connected inside the fuel cell stack body 1 through a fuel flow path 11 and an air flow path 12, respectively. A fuel inlet 111 and a fuel outlet 112 are provided at each end of the fuel flow path 11, respectively, and an air inlet 121 and an air outlet 122 are provided at each end of the air flow path 12, respectively.

The burner 2 is disposed on one side of the fuel cell stack body 1, the burner 2 can be of catalyst type having a porous catalyst as a carrier, which can take place of combustion reaction through feeding the hydrogen and air at normal temperature, the burner 2 having an inlet 21 and an hot air outlet 22, wherein the inlet 21 communicates with the air outlet 122 via an air circulation tube 123, and the air outlet; in one exemplary embodiment, a flat plate 13 having high heat conductivity is provided between the burner 2 and the fuel cell stack body 1, and the fuel cell stack body 1 and the burner 2 are attached on upper and lower sides of the flat plate 13, respectively.

The flat-type evaporator 3 is attached on one side of the burner 2, the farther side away from the fuel cell stack body 1, and the plate-type evaporator 3 communicates with the fuel inlet 111 via a fuel mixture tube 31, wherein inside the plate-type evaporator 3 provided with porous filler materials, so that when the water flowing through the porous filler materials leading to expansion and separation to enhance heat transfer efficiency.

The composite pipe 6 having one end of the inner pipe 61 extending into of the plate-type evaporator 3, wherein an intermediate layer pipe 62 fitted on the outer periphery of the inner tube 61, an outer pipe 63 fitted on the outer peripheral of the intermediate layer pipe 62, one end of the outer pipe 63 communicates with the plate-type evaporator 3, and the outer tube 63 and the intermediate layer pipe 62 are interconnected.

In an exemplary embodiment, the other end of the intermediate layer pipe 62 is connected to an external supply of fuel source (not shown) via a supplementary fuel pipe 621, the other end of the inner pipe 61 is connected to a water pipe 611, and the other end of the outer pipe 63 is connected to a fuel pipe 631.

The gas-water separator 5 communicating with the gas outlet 112 of the fuel cell stack body 1 via a connecting tube 51 for receiving and separating residual fuel and water for recycling, introducing a part of recycled fuel to the burner 2 inlet 21 to mix with the air that flows out of the air outlet 122 of the fuel cell stack body 1 into the burner 2 for burning, wherein the recycled fuel is flowing through a first fuel tube 53 and fuel pump 531 and connecting to the fuel tube 631, mixing the recycled fuel with the refilled fuel from the supplementary fuel tube 621 and the intermediate layer tube 62, and introducing into the plate-type evaporator 3, wherein the recycled water is connected to a water feed tube 52, a water pump 521 and a water supplementary water tube 522 for outside water supply (not shown), obtaining sufficient pure water supply by the water pump 521 and introducing into the plate-type evaporator 3 through a water feed tube 611 and an inner layer tube 61.

The plurality of multilayer pipes 4 provided on the peripheral of the fuel cell stack body 1, wherein each of the multilayer pipes 4 is composed of an outer pipe 42 covering the peripheral of an inner pipe 41, one end of the inner pipe 41 communicating with the hot air outlet 22 of the burner 2 for guiding the hot air output from the burner 2, and the other end of the inner pipe 41 is an exhaust outlet 411, and the outer pipe 42 receiving the fresh air from one end inlet 421 and communicating with the air inlet 121 of the fuel cell stack body 1, wherein the other end of the outer pipe 42 that receives the fresh air being heated by the inner pipe 41 while flowing into the fuel cell stack body 1

In an exemplary embodiment of the present invention, the fuel cell stack body 1 having a plurality of multilayer pipes 4, each of multilayer pipes 4 surrounding the circumference of the fuel cell stack body 1 in a fence-type arrangement and connecting together, thus providing a better effect of heat exchange between the fuel cell stack body 1 and outer pipes 42, wherein the outer pipes 42 of multilayer pipes 4 is provided with a preheater 7 at the fresh air inlet 421, so that the fresh air is preheated before introducing into the outer pipe 42.

During operation, the residual fuel received from the fuel outlet 112 of the fuel cell stack body 1 after incomplete reaction is introduced by the feed tube 51 into the gas-water separator 5 for separation and output as recycled fuel and water, wherein a part of the recycled fuel (about 20%) that flows through the second fuel tube 54 is introduced to mix with the air of incomplete reaction from the fuel cell stack body 1 that flows through the circulation air tube 123, and then guided through the inlet 21 into the burner 2 for burning, wherein the generated heat is used for heating the plate-type evaporator 3 and the fuel cell stack body 1, and the residual heat is fed through the air outlet 22 and discharged through the inner tube 41 and the exhaust outlet 411.

The residual of recycled fuel (about 80%) is fed through the second fuel tube 53, the fuel pump 531, the fuel tube 631 and the outer layer tube 63, mixing with the external fuel through supplementary fuel tube 621 and the intermediate layer tube 62, and then feeding into the plate-type evaporator 3. The recycled water is fed through the water feed tube 52 and water pump 521 for refilling the water from external supply 522 on demand, and feeding into the plate-type evaporator 3 through the water feed tube 611 and inner layer tube 61.

The plate-type evaporator 3 is adopted to absorb heat from the burner 2 and convert the water into steam and mix with the fuel introduced from the outer layer tube 63 and intermediate layer tube 62, and feed into the fuel cell stack body 1 via the fuel mixture tube 31 and the fuel inlet 111 of the fuel flow path 11. The outside fresh air is introduced in through air inlet 421 and warmed up through preheater 7, and then introduced into the air inlet 121 through the outer pipe 42, wherein the air flows in the outer pipe 42 can be further heated by the inner pipe 41, and then fed into the air flow path 12 for reaction with the fuel that mixes with steam in the flow path 11 of the fuel cell stack body 1.

The structure of the fuel cell power generation module of the present invention presents features summarized as follows:

1) The fuel cell stack body 1, the burner 2 and the flat-plate type evaporator 3 having arranged in a top-down stacked structure and direct contact between each other to maintain a better thermal conductivity, and the fuel cell stack body 1 that combines with a reformer (not shown) being arranged on the top of the burner 2 to absorb the high temperature air from the burner 2, thus the thermal conduction and radiation from the burner 2 and the thermal energy of the power generation module can be applied to the fuel cell stack body 1. It can effectively reduce the heat loss, the operating temperature of the burner 2, and the risk of overall system operation.
2) The power generation module of the present invention is assembled in vertical stack and detachable with components being connected with tubes for convenient maintenance.
3) The external fresh air can be heated by the preheater 7, in addition, the air also absorbs heat from the burner 2 through high temperature air flowing in the inner pipe 41, preheating the air to a temperature required in the inlet of the outer pipe 42, and taking the full advantage of the heat generated by the burner 2.
4) The burner 2 of the present invention is a catalyst type porous media burner, not only to avoid hydrogen tempering, but also maintain a stable system operation without turning off the flame while the fuel is in a lean zone, meanwhile, by means of a gas-water separator 5 and a recycling mechanism to regulate the amount of recycled fuel to control the temperature of the burner 2 to improve the efficiency of fuel utilization and power generation of the present invention.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fuel cell power generation module, comprising:
a fuel cell stack body combined with a reformer, wherein a positive electrode and a negative electrode are connected inside the fuel cell stack body through a fuel flow path and an air flow path, respectively, wherein a fuel inlet and a fuel outlet are provided at each end of the fuel flow path, respectively, and an air inlet and an air outlet are provided at each end of the air flow path, respectively;
a burner rendered at one side of the fuel cell stack body, wherein the burner has an air input port communicating with the air outlet of the air flow path and a hot air outlet;
a plate type evaporator attached on a side of the burner farther from the base of the fuel cell stack;
a gas-water separator communicating with the gas outlet of the fuel cell stack body for receiving and separating residual fuel and water for recycling, introducing a part of recycled fuel to the burner inlet to mix with the air that flows out of the burner air outlet into the burner for burning, heating the air that exits from the hot air outlet of the burner, wherein a portion of heat is directly transferred to the plate-type evaporator and the fuel cell stack body, wherein the recycled fuel is flowing through the plate-type evaporator after refueling, and the recycled water is introduced into the plate-type evaporator after refilling, and the plate-type evaporator absorbing the heat of the burner and converting the water into steam that flows with the fuel into the fuel inlet of the fuel cell stack body;
a plurality of multilayer pipes provided on the peripheral of the fuel cell stack body, wherein each of the multilayer pipe is composed of an outer pipe surrounding on the peripheral of an inner pipe, wherein one end of the inner pipe communicating with the hot air outlet of the burner for guiding the hot air output from the burner, wherein the outer pipe introduces a fresh air from one end into the outer pipe, and the other end of the outer pipe communicating with the air inlet of the fuel cell stack body receives the fresh air being heated by the inner pipe while flowing into the fuel cell stack body.

2. The fuel cell power generation module of claim 1, wherein a plate having high heat conductivity is mounted between the fuel cell stack body and the burner, wherein the fuel cell stack body and the burner are attached on the up and bottom sides of the plate, respectively.

3. The fuel cell power generation module of claim 1, wherein the recycled fuel and water separated by the gas-water separator were delivered to the plate-type evaporator through a composite pipe having an inner pipe for guiding recycled water to the plate-type evaporator, an outer pipe for guiding recycled fuel to flow through the plate-type evaporator, and an intermediate pipe for guiding externally refilled fuel to flow through the plate-type evaporator.

4. The fuel cell power generation module of claim 1, wherein a plurality of multilayer pipes provided on the peripheral of the fuel cell stack body are connected each other and arranged in parallel fence fashion surrounding the circumference of the fuel cell stack body.

5. The fuel cell power generation module of claim 1, wherein the burner is a catalyst type burner having a porous catalyst carrier for generating combustion reaction with hydrogen and air at room temperature.

6. The fuel cell power generation module of claim 1, wherein porous filler materials were furnished inside the plate-type evaporator for separation and expansion of the water that passes through the plate-type evaporator to increase heat transfer efficiency.

7. The fuel cell power generation module of claim 1, wherein the fresh air is preheated by a preheater prior to entering the outer pipe of the multilayer pipe.
